(19) United States
(12) Patent Application Publication
(10) Pub. No.: US 2007/0289694 A1
(43) Pub. Date: Dec. 20, 2007

(54) Method for laying carcass reinforcement plies

(75) Inventors: Daniel Macheffe, Veyre-Monton (FR); Michel Deboeuf, Vic-Le-Comte (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNIQUE S.A., GRANGES-PACCOT (CH)

(21) Appl. No.: 11/812,313

(22) Filed: Jun. 18, 2007

Related U.S. Application Data
(60) Provisional application No. 60/832,973, filed on Jul. 25, 2006.

(30) Foreign Application Priority Data
Jun. 16, 2006 (FR) 06/05569

(51) Int. Cl. B29D 30/30

(52) U.S. Cl. 156/133

(57) ABSTRACT

During manufacture of a tire, a carcass reinforcement ply is wound on a cylindrical laying surface on which have been deposited a pair of profiled elements spaced apart along the cylinder axis. The reinforcement ply is fed onto the laying surface while being pressed thereagainst by an application roller which is deformable so as to conform to both the cylinder diameter and the larger radii defined by the profiled elements. Additional rollers can be positioned upstream of the application roller for pressing the ply against respective ones of the profiled elements. A transporter supports one or both the end portions of the ply as they leave a feeder conveyor and approach the laying surface.

The present applications claims priority under 35 U.S.C. §§119 and/or §365 to patent application Ser. No. 06/05569 filed in France on Jun. 16, 2006, and U.S. Provisional Application Ser. No. 60/832,973 filed on Jul. 25, 2006.

### BACKGROUND

The invention relates to the field of manufacturing tires intended to be fitted on motor vehicles, and more particularly to manufacturing what are called self-supporting tires capable of enabling the vehicle to travel at reduced pressure over a given distance.

These tires are characterised in that they comprise reinforcing threads located in the sidewalls of the tire which bear the load when the air pressure in the tire is close to zero. These sidewall reinforcing threads are in the form of rubber profiled elements of great thickness compared with the other profiled elements arranged in the tire in this zone, the, composition of which is adapted, and which are generally placed between the inner lining rubber and the carcass reinforcement ply.

The manufacture of a tire blank of self-supporting type on conventional manufacturing means consists, in known manner, of depositing by winding the various profiled elements which constitute the blank of the tire on a rotary drum of generally cylindrical form, starting with the sealing rubber, then laying in succession the profiled sidewall reinforcement elements of great thickness, the carcass reinforcement ply, the profiled filler elements for the bottom zones and the heel reinforcement rings; the rest of the components do not differ from the components used conventionally in tires.

In what is called a “radial carcass” tire, the carcass reinforcement ply is formed of cords, whether textile or metallic, coated in a rubber mix. The cords are oriented axially, perpendicular to the direction of laying. The rubber mix forms rubber bridges in the space between two cords.

The carcass reinforcement ply or the profiled elements are generally in the form of a length of strip or ply, supplied by appropriate servers located opposite the assembly drum.

It is important, during the entire assembly process, to make sure that the products stick to one another, and to avoid trapping air between the layers of product so as not to adversely affect the performance of the tire.

One specific problem linked with the assembly of what are called self-supporting tires lies in the laying of the carcass reinforcement ply, which is generally radial, owing to the great thickness of the profiled sidewall reinforcement elements. The result is difficulty in evacuating the air trapped between the profiled sidewall reinforcement elements, the carcass reinforcement ply and the sealing rubber. Furthermore, the variation in the laying circumferences causes additional difficulty in controlling the radial orientation of the cords of the carcass reinforcement ply.

This problem, which is known to the person skilled in the art, is generally solved by modifying the profile of the assembly drum on which the components are deposited. Circumferential grooves are formed in the zone where the profiled sidewall reinforcement elements are deposited so as to ensure that the meridian profile of the drum is substantially rectilinear at the time when the carcass reinforcement ply is deposited.

One solution of this type is described by way of example in U.S. Pat. No. 5,591,288, or alternatively in publication EP 1 625 931 (corresponding to Higuchi et al. U.S. Publication No. 2006/0254695).

Although the advantages linked to this type of solution need no longer be demonstrated, it should however be observed that using drums comprising these circumferential grooves requires extensively modifying conventional drums of generally cylindrical form, or developing specific drums for producing this type of tire, as is described, by way of example, in publications U.S. Pat. No. 6,863,106 or U.S. Pat. No. 6,769,468. Furthermore, these modifications require means making it possible to modify the axial distance between the grooves, as a function of the dimension of the tire to be assembled, which accordingly increases the cost of this type of drum.

### OBJECTS AND SUMMARY OF THE DISCLOSURE

The object of the invention is to propose a solution to the problem of laying the carcass reinforcement ply of self-supporting tires, in which it is not necessary to modify the assembly drum, and which can be adapted to the manufacturing means used for producing all types of tires. In this case, the assembly drum does not comprise lateral grooves level with which the profiled elements of great thickness are laid, which amounts to saying that the generatrices of the drum are substantially rectilinear and located at one and the same distance from the axis of rotation of the drum so as to define a substantially cylindrical receiving surface.

The problem to be solved in this context is linked to the fact that the carcass reinforcement ply must be deposited on a meridian profile having significant radial variations. This is because, after having deposited a thickness of inner lining rubber a first generally cylindrical laying surface of circular section of radius R₁ which is substantially planar is obtained. The circumferential development of this surface is substantially equal to 2×π×R₁.

The profiled sidewall reinforcement elements are laid on this first laying surface, and are axially spaced apart from one another. If the thickness of these profiled elements is denoted e, the back of the profiled elements is placed at a radius R₂ where R₂=R₁+e. The circumferential development on the back of the profiled elements is substantially equal to 2×π×R₂, and this development is substantially higher than the development measured at the level of the first laying surface. The sidewall reinforcing threads will be considered to have a great thickness when the ratio R2/R1>1.05.

The meridian line then describes a cambered profile, the distance of which from the axis of rotation of the drum is at least equal to R₁, and at most is equal to R₂, which represents the total of R₁+e, and in which the ratio R₂/R₁ is greater than or equal to 1.05.

So that the cords of the carcass reinforcement ply remain parallel to each other and to the axial direction once the reinforcement ply has been laid on the profile formed by the first laying surface and by the profiled sidewall reinforcement elements, it is advisable to adjust the elasticity of the rubber bridges, by stretching them, so as to compensate for the variations in development linked with the differences in radius between the crown of the profiled elements which is at the radius R₂ and the central part, which is at the radius R₁. The method of laying by winding the carcass reinforcement ply according to the invention is characterised in that the ply C is delivered towards the surface of the drum at a linear speed which is substantially equal to the circumferential speed of the first laying surface, while exerting on the reinforcement ply C, using a deformable application roller, a pressure in the radial direction along a meridian line corresponding substantially to the points at which the ply is placed in contact with the first laying surface.

The effect of the application roller is to laminate the carcass reinforcement ply, in particular on the back of the profiled elements, and to force the rubber bridges located level with these profiled sidewall reinforcement elements to become distended so as to fit snugly against the laying circumference on the back of the profiled sidewall reinforcement elements, and so that the reinforcement cords remain aligned and parallel to the axial direction.

In order to obtain this laminating effect, it is important, as will be seen hereafter, to adjust the pressure exerted by the application roller and if necessary to arrange a laminating roller upstream of the application roller to increase the desired effects, when the thickness e of the profiled sidewall reinforcement elements becomes very great.

The means used to implement the method are known means widely used in the tire industry. The object of the method according to the invention is to propose an original form of collaboration between these means which makes it possible to dispense with the need to modify conventional assembly drums.

### BRIEF DESCRIPTION OF THE DRAWINGS

The following description is based on FIGS. 1 and 2, which illustrate a preferred embodiment of the invention, in which:

FIG. 1 depicts a diagrammatic view in an axial direction B-B of a laying device for implementing the process according to the invention,

FIG. 2 depicts a diagrammatic view in a longitudinal direction A-A of this same device.

### DESCRIPTION OF PREFERRED EMBODIMENTS

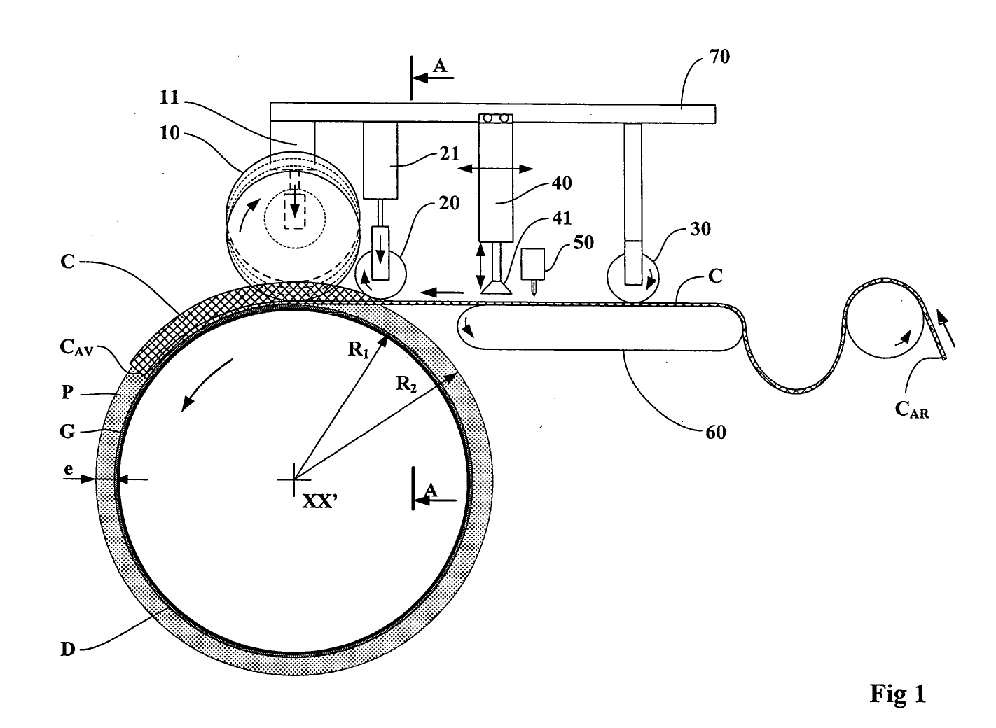

In FIG. 1 there can be seen an assembly drum D of cylindrical shape, of a circular section of axis XX′. On this drum have been deposited an internal sealing rubber G and profiled elements P of thickness e. The first laying surface defined by the outer surface of the rubber G has a radius R₁.

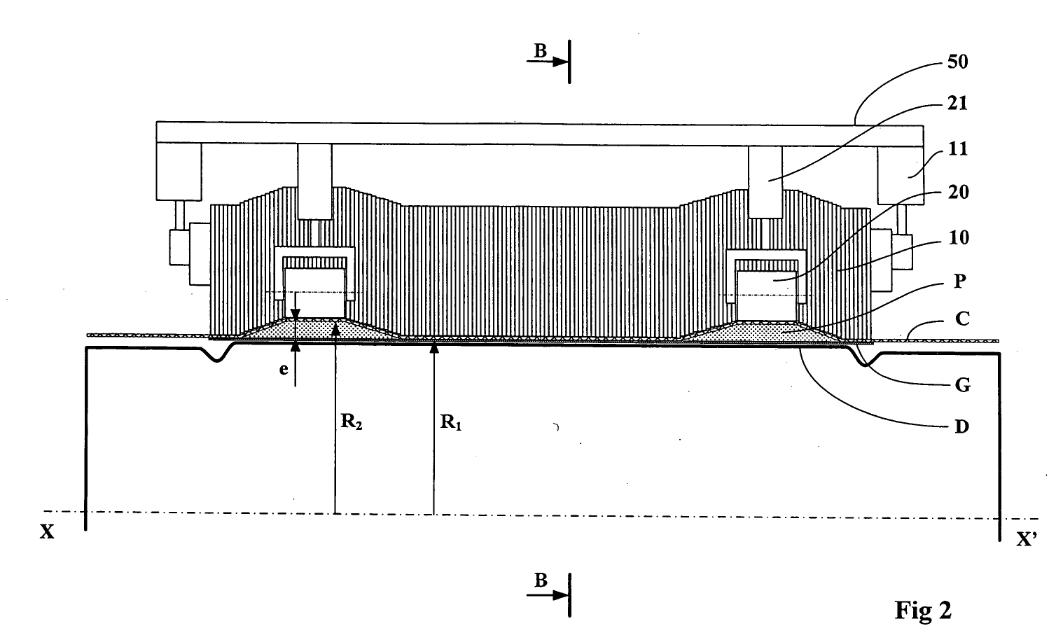

FIG. 2 shows the two profiled sidewall reinforcement elements P laid axially spaced apart from one another. The back of the profiled elements is located at a radius R₂ from the axis XX′.

The following description is based on the assembly of a tire comprising a simple structure formed of a sealing rubber, two profiled sidewall reinforcement elements and a carcass reinforcement ply.

It goes without saying that the method according to the invention can apply equally well to a structure comprising a plurality of carcass reinforcement plies and a plurality of profiled sidewall reinforcement elements, since the laying profile of the carcass reinforcement ply(plies) exhibits major variations of laying radius.

In FIG. 1, the carcass reinforcement ply C is shown in the form of a length of ply comprising a front edge C_{AV} and a rear edge C_{AR}. The front edge C_{AV} of the ply is laid on the drum and the rear edge C_{AR} is engaged in the ply server shown in the form of a belt feeder 60.

FIG. 2 shows the cambered profile of the meridian M of the laying surface on which the carcass reinforcement ply C is deposited and which is represented by a bold dotted line. It will be noted that the back of the profiled elements is located at a radius R2 from the axis of rotation XX′ of the drum and that the central part on which no additional profiled element has been deposited has remained at the radius R1. The ratio R₂/R₁ is greater than 1.05. In practice this ratio does not exceed 1.15.

The various arrows indicate the direction of the movements of the members for depositing the reinforcement ply when the ply is brought into the direction of laying. Considering the longitudinal direction, the ply is directed in the direction of laying from upstream to downstream.

A frame 70 supports an application roller of multidisc type 10 which is deformable in the radial direction by means of an application piston-cylinder unit 11. The point of application of the roller 10 corresponds substantially with the point of contact of the reinforcement ply C with the first surface of radius R₁. The application roller 10 is provided with a raising and lowering motion in order to come into contact with the laying surface as required. The width of the application roller 10 corresponds substantially to the width of the ply C as illustrated in FIG. 2.

The deformable application roller represented in the example of implementation of the process is a commonly used roller of multidisc type, formed of a set of discs which are juxtaposed relative to one another and mobile relative to one another in the radial direction. A pneumatic system forces each of the discs to move in the radial direction until the disc comes into contact with the laying profile.

Entirely equivalently, it is possible to use a foam application roller, the elasticity of which is suitable for also fitting snugly to the form of the laying profile. This type of roller is particularly suitable when the thickness of the profile P is relatively low.

The belt feeder 60 of the server delivers the ply C onto the drum from a storage means (not shown). A synchronisation wheel 30 makes it possible to measure the linear speed of the belt feeder 60. This synchronisation wheel may advantageously be replaced by a roller so as to avoid any sliding between the belt 60 and the ply C.

In this manner, the speed of rotation of the drum being constant, and the radius R₁ of the first surface being known, it is possible to regulate the speed of the belt feeder 60 such that the linear speed of this belt is equal to the circumferential speed of the first surface of radius R₁.

A cutting tool 50 is located downstream of the synchronisation wheel 30 so as to section the reinforcement ply C in order to obtain a length of ply of the desired length corresponding to the development of the first surface and which is substantially equal to 2×π×R₁.

It is also possible, without departing from the scope of the invention, and in certain configurations, to apply a very slight laying tension, by setting the belt feeder 60 to a speed which is very slightly less than the circumferential speed of the first laying surface so as to promote the application of the reinforcement ply onto the first laying surface. This effect may be obtained with a reduction in the linear speed of the belt feeder 60, generally less by 2% than the circumferential speed of the first laying surface.

The point of application of the roller 10 is located at the level of the meeting points between the plane of the ply C and the first surface. It will in fact be observed that the laminating effect decreases when the roller is placed downstream of these contact points.

The application roller 10 exerts a pressure in the radial direction on the reinforcement ply C. The application pressure must be sufficiently high to bring about the laminating phenomenon mentioned above, without however deforming the profiled element P. This application pressure may vary from 0.1 MPa to 0.5 MPa according to the thickness of the product to be laid. Usually, for a dimension of 16″, and a diameter of the application roller of 100 mm, a pressure of 0.3 MPa is applied for a profiled element P having a thickness of 12 mm.

It will nevertheless be noted that the greater the thickness e of the profiled element P, the more it is necessary to exert a high application pressure using the roller 10.

To solve this difficulty, it is proposed, still within the context of the invention, to arrange laminating rollers 20 upstream of the application roller. The laminating rollers 20 are supported by the frame 70 by means of piston-cylinder units 21. These laminating rollers 20 exert a pressure on the ply level with the back of the profiled elements P as illustrated in FIG. 2. For the same reasons as previously, the rollers are arranged, in the longitudinal direction, on the meridian line corresponding substantially to the points at which the ply is placed in contact with the back of the profiled elements P.

The application pressure may vary from 1 MPa to 10 MPa. Preferably the pressure exerted by the laminating roller at the level of the ply varies between 2 MPa and 6 MPa.

The laying of the rear edge of the ply C_{AR} may also cause problems, in that when said rear edge leaves the belt feeder 60 a gap remains free, between the belt feeder and the drum, over which it is not possible to control the linear speed of the ply at each of the points and, consequently, to keep the cords of the ply parallel to each other and to the axial direction.

To this end, and still in the context of the invention, it is proposed to arrange a transporter means 40, moving in the longitudinal direction, provided with means capable of gripping the rear edge C_{AR} of the ply P over the entire width of the ply. These means may be formed, according to the nature of the reinforcement cords, by a set of suction cups 41 or alternatively by magnets, arranged in a line, parallel to the axial direction, or alternatively perpendicular to the longitudinal direction.

The laying of the carcass reinforcement ply is finished by gripping the rear edge C_{AR} of the carcass reinforcement ply C using the gripping means of the transporter means and the linear speed of the transporter means is adjusted such that it is substantially equal to the circumferential speed measured on the first circumference. The rear edge C_{AR} of the ply is deposited on the drum D at the level of the meridian line corresponding substantially to those points at which the ply is placed in contact with the back of the profiled elements P. The laying is finished by passing the rear edge C_{AR} and the front edge C_{AV} of the ply beneath the application roller 10 so as to effect butt-jointing of the two ply edges.

It is observed that by controlling the speed of laying the rear edge as close as possible to the laying surface it is possible to maintain good radial orientation of the reinforcement cords contained in the ply and that the butt-jointing of the rear edge C_{AR} and the front edge C_{AV} can be effected by controlling the number of superposed cords in accordance with the manufacturing tolerances imposed in this zone.

The transporter means 40 can also be used to start the laying operation, and to make the front ply edge C_{AV} cross the space between the end of the belt feeder 60 and the laying surface. The ply front C_{AV} is then deposited directly on the laying surface, substantially at the level of the contact zone of the application roller 10. This makes it possible to ensure that the reinforcement cords of the ply front C_{AV} are perfectly aligned in the axial direction. Once the ply front has been deposited on the laying surface, the transporter means is brought back upstream, and the application roller 10 is lowered on to the laying surface. So as best to preserve the radial orientation of the front and rear ply edges (C_{AV}, C_{AR}), a satisfactory result has been obtained by depositing in succession that part of the ply located at the centre, then that part of the ply located axially at both ends. This result may be obtained easily by releasing the gripping means 41 in the desired order.

This operating method also has the advantage of permitting better evacuation of the air between the two profiled elements of great thickness P.

The preferred embodiment of the invention described in the present application comprises a transporter means 40. However, it is possible to perform a similar function using any means capable of reducing the free path of the ply edges (C_{AV}, C_{AR}). This result may be obtained for example by arranging the downstream end of the belt feeder 60 as close as possible to the laying surface of the assembly drum. In this manner, the front and rear edges leave the belt feeder as close as possible to the application points.

According to this arrangement, the cutting means 50 are then arranged upstream of the synchronisation wheels 30.

The laying means may be controlled without difficulty by an automatic means in accordance with processes known in the tire industry.

What is claimed is:

1. A method of laying a carcass reinforcing ply on a cylindrical drum of a tire, by winding the carcass reinforcing ply upon a first laying surface whose generatrices are substantially rectilinear, and on which have been deposited axially spaced profiled elements of maximum thickness e, wherein a profile of the first laying surface has a minimum radius R₁ disposed axially between the profiled elements and a maximum radius R₂ at the profiled elements, wherein R₂=R₁+e and wherein the ratio R₂/R₁ is at least equal to 1.05, the carcass reinforcing ply being delivered towards the first laying surface at a linear speed substantially equal to the circumferential speed of the first laying surface, while an application roller of deformable profile exerts on the reinforcement ply a radially inward pressure along a meridian plane located substantially where the caracass reinforcement ply initially contacts the first laying surface.

2. The laying method according to claim 1 wherein the application roller has an axial width corresponding substantially to the axial width of the carcass reinforcing ply.

3. The laying method according to claim 1 wherein the application roller comprises a multidisc roller having discs movable radially relative to one another.

4. The laying method according to claim 1 wherein the application roller comprises a foam roller.

5. The laying method according to claim 1 wherein the pressure exerted by the application roller on the carcass reinforcement ply is between 0.1 Mpa and 0.5 Mpa.

6. The laying method according to claim 1 wherein a further radially inward pressure is exerted on portions of the reinforcement ply coming into contact with the profiled elements by laminating rollers arranged axially level with respective profiled elements upstream of the application roller on a meridian plane corresponding to the points where the carcass reinforcement ply makes initial contact with the maximum radius of the profiled elements.

7. The laying method according to claim 6 wherein the axial width of each laminating roller is substantially equal to the axial width of the respective profiled element.

8. The laying method according to claim 6 wherein each laminating roller applies a radially inward pressure of between 1 MPa and 10 Mpa.

9. The laying method according to claim 8 wherein the radially inward pressure is between 2 MPa and 6 MPa.

10. The laying method according to claim 1 wherein the carcass reinforcement ply comprises parallel reinforcing cords embedded in rubber and includes front and rear edges disposed at respective front and rear portions thereof, wherein as at least one of the front and rear edges approaches the first laying surface, the carcass reinforcement ply is supported by a movable transporter to keep the reinforcing cords substantially parallel to the drum axis, the transporter subsequently releasing the carcass reinforcement ply.

11. The method according to claim 10 wherein the at least one edge is the front edge.

12. The method according to claim 10 wherein the at least one edge is the rear edge.

13. The method according to claim 10 wherein the at least one edge consists of the front and rear edges.

14. The laying method according to claim 10 wherein the transporter moves at substantially the same linear speed as the carcass reinforcement ply.

15. The laying method according to claim 10 wherein the transporter supports a portion of the carcass reinforcement ply disposed between the drum and a feeder conveyor for the carcass reinforcement ply.

16. A method of laying a carcass reinforcing ply on a cylindrical drum during manufacture of a tire, by winding the carcass reinforcing ply upon a first laying surface whose generatrices are substantially rectilinear, and on which have been deposited axially spaced profiled elements of maximum thickness e, wherein a profile of the first laying surface has a minimum radius R₁ disposed axially between the profiled elements and a maximum radius R₂ at the profiled elements, wherein R₂=R₁+e, and wherein the ratio R₂/R₁ is at least equal to 1.05, the carcass reinforcing ply being delivered towards the first laying surface by a feeder conveyor at a linear speed substantially equal to the circumferential speed of the first laying surface, wherein the carcass reinforcement ply comprises parallel reinforcing cords embedded in rubber and includes front and rear edges disposed at respective front and rear portions thereof, wherein as at least one of the front and rear edges approaches the first laying surface, a portion of the carcass reinforcement ply disposed between the drum and the conveyor is supported by a movable transporter to keep the reinforcing cords substantially parallel to the drum axis, the transporter subsequently releasing the carcass reinforcement.
